(19) United States
(12) Patent Application Publication
(10) Pub. No.: US 2014/0011658 A1
(43) Pub. Date: Jan. 9, 2014

(54) CERAMIC PARTICLE AND PROCESS FOR MAKING THE SAME

(71) Applicants: Tihana Fuss, Stow, OH (US); Laurie San-Miguel, Cavaillon (FR); Kevin R. Dickson, Little Rock, AR (US); Walter T. Stephens, Cleveland, OH (US)

(72) Inventors: Tihana Fuss, Stow, OH (US); Laurie San-Miguel, Cavaillon (FR); Kevin R. Dickson, Little Rock, AR (US); Walter T. Stephens, Cleveland, OH (US)

(73) Assignee: Saint-Gobain Ceramics & Plastics, Inc., Worcester, MA (US)

(21) Appl. No.: 14/005,278

(22) PCT Filed: Mar. 26, 2012
(86) PCT No.: PCT/US12/30539

§ 371 Date: Sep. 16, 2013

Related U.S. Application Data
(60) Provisional application No. 61/468,773, filed on Mar. 29, 2011.

(51) Int. Cl. C03C 14/00; C03C 10/00

(52) U.S. Cl. CPC C03C 14/006; C03C 10/00
USPC 501/2; 501/32; 264/642

(57) ABSTRACT

A ceramic particle with at least two microstructural phases comprising an amorphous phase, representing between 30 volume percent and 70 volume percent of the particle, and a first substantially crystalline phase comprising a plurality of predominately crystalline regions distributed through the amorphous phase is disclosed. A process for making the ceramic particle is also disclosed.

### CROSS-REFERENCE TO RELATED APPLICATION

This application claims the benefit of U.S. Provisional Application No. 61/468,773 filed Mar. 29, 2011.

### BACKGROUND OF THE INVENTION

Ceramic particles are produced for use in a wide variety of industrial applications. Some of these applications include using a plurality of ceramic particles: as a proppant to facilitate the removal of liquids and/or gases from wells that have been drilled into geological formations; as a media for scouring, grinding or polishing; as a bed support media in a chemical reactor; as a heat transfer media; as a filtration media; and as roofing granules when applied to asphalt shingles.

Examples of patents and patent applications that disclose ceramic particles and methods of manufacturing the same include U.S. Pat. No. 4,632,876, U.S. Pat. No. 7,036,591, CA 1,217,319, US 2010/0167056 and WO 2008/112260.

### SUMMARY

In one embodiment, the present invention is a sintered ceramic particle comprising at least two microstructural phases comprising an amorphous phase, representing between 30 volume percent and 70 volume percent of the particle, and a first substantially crystalline phase comprising a plurality of predominately crystalline regions distributed through the amorphous phase.

In another embodiment, the present invention is a process for producing a sintered ceramic particle. The process may comprise the following steps. Providing a first ceramic material having a fluid conversion temperature and a second ceramic material having a fluid conversion temperature wherein the second ceramic material's fluid conversion temperature is greater than the first ceramic material's fluid conversion temperature. Mixing the materials to form a homogeneous mixture comprising between 30 weight percent and 70 weight percent of the first ceramic material. Forming the mixture into a particle precursor. Heating the precursor to at least the first ceramic material's fluid conversion temperature wherein the first and second ceramic materials cooperate to form an amorphous phase that abuts and embeds an array of predominately crystalline regions. Cooling the precursor to ambient temperature thereby forming a sintered ceramic particle.

### BRIEF DESCRIPTION OF THE DRAWINGS

FIG. 1 is a process flow chart.

### DETAILED DESCRIPTION

As used herein, the phrase “microstructural phase” refers to a sintered ceramic particle's crystalline or amorphous phase(s) which are detectable using an X-ray diffractometer analytical device. A particle may have one or more microstructural phases. The microstructural phase is characterized by the physical arrangement of atoms which form repeating patterns in crystalline phases and. do not form repeating patterns in an amorphous phase.

As used herein, the phrase “fluid conversion temperature” refers to the temperature at which a solid ceramic material begins to soften and thereafter becomes flowable due to an increase in its temperature.

As used herein, the phrase “crush resistance” refers to the particle's ability to withstand crushing. Crush resistance is commonly used to denote the strength of a ceramic particle, such as a proppant, and may be determined using ISO 13503-2:2006(E). A strong proppant generates a lower weight percent crush resistance than a weak proppant at the same closure stress. For example, a proppant that has a 2 weight percent crush resistance is considered to be a strong proppant and is preferred to a weak proppant that has a 10 weight percent crush resistance.

The terms “particle”, “particles”, “proppant” and “proppants” may be used interchangeably herein unless otherwise noted.

Processes for manufacturing ceramic particles have been devised and used for many years to manufacture large quantities of ceramic particles such as proppants. Because proppants are used in a wide variety of geological formations, at different depths and exposed to extremes in temperature and pressure, the physical characteristics of the proppants may need to be customized in order to optimize the performance of the proppant in a particular environment. Some of the properties which may impact the performance of the proppant include: specific gravity, porosity, crush strength and conductivity. Changing one physical property may inherently change one or more of the other properties in an undesirable manner. Consequently, significant effort has been made to develop processes that alter the properties that are important in one application while simultaneously minimizing undesirable changes to the particle's other properties. Furthermore, proppant manufacturers have tried to reduce the cost of manufacturing proppants by eliminating materials and/or process steps without compromising the performance of the proppant.

With regard to producing a proppant having a low, and therefore desirable, crush resistance, certain technical teachings have been used for years to create a proppant this is resistant to crushing while also trying to minimize the cost of the raw materials used to make the proppant. A first well known teaching for improving the proppant's crush strength is to increase the percentage of Al₂O₃ chemical content in the proppant. The Al₂O₃ is calcined at a sufficiently high temperature, such as 1300° C., to convert the transitional crystalline phases to alpha alumina which is known to be strong and therefore highly resistant to crushing. Unfortunately, raw materials that contain high concentrations of Al₂O₃ chemical content are expensive and must be purchased in large quantities which can significantly increase the manufacturing cost of the proppant producer and is undesirable. A second well known technical teaching is that some amorphous ceramic materials, such as glass beads, tend to fracture at low stress and therefore has undesirably high crush resistance when used as an ingredient in a proppant. However, amorphous materials are relatively inexpensive and therefore desirable from a cost perspective. Furthermore, amorphous materials are problematic because they are known to have a fluid conversion temperature well below the minimum temperature needed to convert transitional alumina to alpha alumina. When an amorphous material begins to soften, it may become tacky and individual proppant particles may adhere to adjacent particles thereby forming large, loosely bound agglomerates made up of thousands of individual proppant particles. The proppants also tend to adhere to the inside surfaces of kilns and other equipment used to calcine the proppants. During the time the proppants reside in the kiln, such as a rotary kiln, the proppants may build up an increasingly thick layer of proppants on the inside surface of the kiln which ultimately results in the shut down of the kiln so that it can be cleaned and then restarted. Using the technical teachings described above, some proppant manufacturers have elected to produce proppants having high alumina content, to achieve the desired crush resistance, and low amorphous material, to avoid the problems associated with proppant agglomeration and low crush resistance.

In contrast to the technical teachings described above, the inventors of the invention claimed herein have discovered how to manufacture a proppant wherein regions of predominately crystalline phase ceramic material and a matrix of a predominately amorphous phase ceramic material cooperate to form a proppant that has good resistance to crushing. More specifically, in a proppant of the present invention, predominately crystalline regions are surrounded by and embedded within a matrix of an amorphous ceramic material. The matrix forms a continuous phase through the proppant. The predominately crystalline regions collectively define a discontinuous phase. As described above, amorphous ceramic materials tend to fracture at low stress and therefore have undesirably high crush resistance when used as an ingredient in a proppant. To improve the crush resistance of the normally weak amorphous material, the crystalline material and the amorphous material are selected so that a synergistic relationship is established between the materials which results in the creation of a beneficial stress, such as compressive stress, on the amorphous material. The compressive stress is believed to improve the particle's crush resistance by compressing the amorphous material thereby hindering crack origination and propagation through the amorphous phase. Hindering crack propagation effectively improves the crush resistance of the particle at a specified stress by requiring the exertion of a higher mechanical force to crush the particle. The compressive stress on the amorphous material may be created by selecting the crystalline and amorphous materials so that after forming, heating and cooling the proppant the crystalline material's coefficient of thermal expansion is greater than the amorphous material's coefficient of thermal expansion. The difference in coefficients of thermal expansion may cause the discreet crystalline material to attempt to shrink more than the adjacent amorphous material to which it has been bonded during the cooling step. The difference in the coefficients of thermal expansion is believed to cause the amorphous material to experience compressive stress as it resists the greater relative movement of the crystalline material.

After a ceramic particle has been exposed to a specific thermal profile the coefficients of thermal expansion of the particle's ceramic materials may be determined using the procedure described below. The exact value of a material's coefficient of thermal expansion after heating of the particle may not be critical to the use of that material to manufacture a ceramic particle of this invention. Instead, the size of the difference between the coefficients of thermal expansion is the characteristic that may directly impact the creation of the compressive stress and the resulting resistance to crushing. A difference of at least 0.1×10⁻⁶/° C. may be sufficient to exert a compressive stress. More preferably, the difference in coefficients of thermal expansion may be 0.2 or 0.3×10⁻⁶/° C. For ceramic particles useful as proppants, the coefficient of thermal expansion of the crystalline material may be greater than 6.0, more preferably, greater than 7.0×10⁻⁶/° C. The coefficient of thermal expansion of the amorphous material may be less than 6.0, more preferably, less than 5.0×10⁻⁶/° C.

The quantity of the amorphous ceramic material in a porous ceramic particle of this invention may be between 30% and 70% based on the volume of the particle after heating and cooling of the same. If the amorphous material represents less than 30% of the particle's volume, the amorphous material may not form a continuous phase throughout the particle. The amorphous phase material may represent at least 40%, 45% or even 50% of the particle's volume. Examples of amorphous ceramic materials suitable for use in a porous ceramic particle of this invention include feldspar and nepheline syenite.

To identify a proppant of this invention, the proppants's microstructural phases, the chemical composition of those phases and the coefficient of thermal expansion of those phases should be determined, The identification of these physical characteristics may be determined using the following analytical procedures. With regard to the microstructural phases, an X-ray diffractometer, such as an PANalytical® XRD, is used to detect the existence of one or more crystalline phases. The height of the lines on the X-ray diffraction pattern may be used to determine the relative quantities of each crystalline phase. The location of the lines on the X-ray diffraction pattern horizontal axis is indicative of a microstructural phase. Furthermore, the use of an internal standard may facilitate the analysis of the X-ray diffraction pattern. The amount of amorphous phase material may be calculated as the amount of proppant that is not crystalline. With regard to the proppant's chemical composition, the composition's chemical elements may be determined using X-ray fluorescence (XRF).

After determining the proppant's microstructural phases and chemical composition, the coefficient of thermal expansion of each microstructural phase may be determined using an analytical technique known as dilatometry. A dilatometer, such as a Unitherm 1161 from Anter Corporation, is an instrument capable of measuring the coefficient of thermal expansion (CTE) of a material. The dilatometer may be used to measure the change in length of a rectangular bar test sample as a function of temperature. The bar may be 40 mm long, 25 mm wide and 2 mm high. The CTE is obtained through recording the change in relative length of the rectangular bar upon cooling from below the fluid conversion temperature to 25° C. Commonly, the CTE is reported as units of 10⁻⁶ /° C., such as 5×10⁻⁶/° C., which represents a change of 0.0001% of the rectangular bar's length per every 1° C. change in temperature.

Test samples of each microstructure amorphous phase can be prepared using reagent grade raw materials, in a formulation equal to the determined chemical composition, which are then melted at high temperatures greater than the fluid conversion temperature. These melted samples of the amorphous phase are ground to a fine powder and formed in the shape, such as a rectangular bar which is suitable to dilatometry measurements, and sintered to high temperature. The same XRD and XRF techniques described above can be used to confirm the phase and chemical content of each crystalline and amorphous phase test sample.

The quantity of crystalline alumina material in a porous ceramic particle of this invention may be between 30% and 70% of the particle's volume. Preferably, the quantity of crystalline alumina material may be greater than 30%, 35% or even 40% of the particle's volume. If the quantity of crystalline alumina material is less then 30 volume percent, there may not be enough crystalline alumina to create a sufficient amount of compressive stress on the amorphous material to provide acceptable resistance to crushing. If the quantity of crystalline alumina material is greater than 70 volume percent, there may not be sufficient improvement in the crush resistance to justify the cost associated with using alumina containing ceramic material instead of a less expensive amorphous material. In a porous ceramic particle of this invention, the crystalline material may be a single crystalline phase, such as alpha alumina. Alternatively, the crystalline alumina may be a mixture of transitional phases or a combination of alpha alumina and one or more transitional phases.

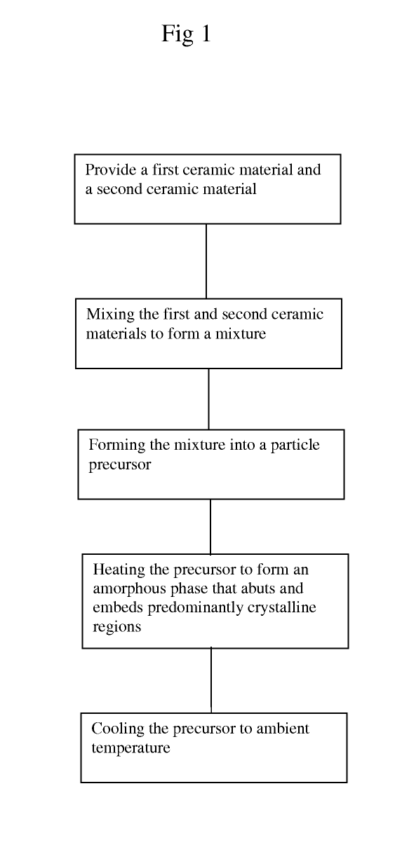

Shown in FIG. 1 is a flow chart of a process that includes the following steps. Step 20 includes providing a first ceramic material and a second ceramic material. The first ceramic material has a fluid conversion temperature. The second ceramic material has a fluid conversion temperature that is less than the fluid conversion temperature of the first ceramic material. Step 22 includes mixing the first and second materials to form a mixture wherein the mixture comprises between 30 and 70 weight percent of the first ceramic material. Step 24 is directed to forming the mixture into a particle precursor. Step 26 includes heating the precursor to a maximum temperature that is no less than the first ceramic material's fluid conversion temperature and no greater than the second ceramic material's fluid conversion temperature wherein the first and second ceramic materials cooperate to form an amorphous phase that abuts and embeds predominately crystalline regions. During the heating step, the temperature of the precursor must at least equal and perhaps slightly exceed the first material's fluid conversion temperature. In step 28 the heated precursor is cooled to ambient temperature thereby creating a sintered ceramic particle.

With regard to step 22, the mixture may optionally include other materials such as binders and solvents. Suitable solvents include water and some alcohols. A binder may be one or more materials selected from organic starches, such as drilling starch, as well as gums or resins that are sold commercially for such purposes. A binder may also be an inorganic material such as clay or an acid. Binders are usually added in an amount less than 10 weight percent of the mixture and may be added dry or as a solution. While a binder may be responsible for some level of porosity in a ceramic particle, binders are not considered pore formers herein. The composition of the mixture may be limited to less than 0.1 weight percent of one or more pore formers selected from the list consisting of a transient pore former, an in-situ pore former, and combinations thereof. Transient pore formers may be limited to less than 0.05 weight percent of the mixture. In-situ pore formers may be limited to less than 0.01 weight percent of the mixture. In one embodiment, the mixture will not include any pore formers.

With regard to step 24, a particle precursor is defined herein as a particle wherein the first and second ceramic materials are distributed therethrough and solvents, such as water, have been removed so that the precursor's loss on drying (LOD) after heating to between 110° C. and 130° C. for two hours is less than one percent of the precursor's starting weight. The precursor may or may not contain optional ingredients such as a binder. The precursor may include at least 30 weight percent of the first ceramic material and at least 30 weight percent of the second ceramic material. In some embodiments, the precursor may include between 60 weight percent and 70 weight percent of the first ceramic material and between 30 weight percent and 40 weight percent of the second ceramic material.

Forming a particle precursor may be achieved by processing the mixture through a machine such as an Eirich RO2 mixer, which is available from American Process Systems, Eirich Machines Inc. of Gourney, Ill., USA. The action of the mixer causes the formation of a large number of small generally spherical balls of mix which may be referred to as particle precursors or greenware. If the greenware contains optional ingredients, such as solvents and binders, the optional ingredients may be removed by drying the greenware in an oven to a sufficiently high temperature, such as 200° C. or higher, to drive the optional ingredients from the greenware. If desired, the particle precursors may be processed through a screening apparatus that includes a No. 8 ASTM sieve designation, which has 2.36 mm apertures, and a No. 70 ASTM sieve designation, which has 212 μm sieve apertures. The precursors selected for heating in step 26 may flow through the No. 8 sieve and not flow through the No. 70 sieve.

In step 26, the precursor is heated to a maximum temperature which is below the fluid conversion temperature of the second ceramic material and above the fluid conversion temperature of the first ceramic material. In some embodiments, the precursor may be heated to a maximum temperature which is above the melting temperature of the first ceramic material which is below the sintering temperature of the second ceramic material. When the temperature to which the precursor is heated exceeds the fluid conversion temperature of the first ceramic material, the first ceramic material may convert from a solid material to a flowable material and then flow over the second ceramic material.

With regard to step 20, both the first and second ceramic materials may be provided as powders which include a plurality of granules. In particular embodiments, granules may range from 1 to 10 microns, more specifically from 6 to 8 microns. The first and second ceramic materials may be selected no that the first ceramic material's coefficient of thermal expansion after heating and cooling as described above is at least 10% higher than the second ceramic material's coefficient of thermal expansion after experiencing the same heating and cooling regime. After heating and cooling, die coefficient of thermal expansion of the first ceramic material may be 20% or even 30% higher than the coefficient of thermal expansion of the second ceramic material. While the exact difference between the fluid conversion temperature of the first ceramic material and the fluid conversion temperature of the second ceramic material may not be critical, a difference of 50° C. may be workable in particular embodiments.

A suitable first ceramic material may be selected from the group consisting of bauxite, alumina, kaolin, clays, alumino-silicates, and magnesium silicates. A suitable second ceramic material may be selected from the group consisting of feldspar and nepheline syenite.

The above description is considered that of particular embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law.

What is claimed is:

1. A sintered ceramic particle, comprising: at least two microstructural phases comprising an amorphous phase, representing between 30 volume percent and 70 volume percent of said particle, and a first substantially crystalline phase comprising a plurality of predominately crystalline regions distributed through said amorphous phase.

2. The sintered ceramic particle of claim 1 wherein said amorphous phase forms a continuous matrix through said particle and said crystalline regions collectively form a discontinuous phase.

3. The sintered ceramic particle of claim 2 wherein said amorphous phase has a coefficient of thermal expansion, said first substantially crystalline phase has a coefficient of thermal expansion and said first substantially crystalline phase's coefficient of thermal expansion is no less than said amorphous phase's coefficient of thermal expansion.

4. The sintered ceramic particle of claim 3 wherein said first substantially crystalline phase's coefficient of thermal expansion is at least 5% greater than said amorphous phase's coefficient of thermal expansion.

5. The sintered ceramic particle of claim 3 wherein said first substantially crystalline phase's coefficient of thermal expansion is at least 10% greater than said amorphous phase's coefficient of thermal expansion.

6. The sintered ceramic particle of claim 1 wherein said amorphous phase abuts at least one of said predominately crystalline regions at an interface and said interface exhibits stress.

7. The sintered ceramic particle of claim 6 wherein said particle exhibits compressive stress at said interface.

8. The sintered ceramic particle of claim I wherein said amorphous phase represents at least 40 volume percent of said particle's volume.

9. The sintered ceramic particle of claim 1 wherein said amorphous phase represents at least 50 volume percent of said particle's total volume.

10. The sintered ceramic particle of claim 1 further comprising a second substantially crystalline phase having a coefficient of thermal expansion no less than said amorphous phase's coefficient of thermal expansion,

11. A process, for producing a sintered ceramic particle, comprising the steps of:
(a) providing
i) a first ceramic material having a fluid conversion temperature, and;
ii) a second ceramic material having a fluid conversion temperature greater than the fluid conversion temperature of said first ceramic material;
(b) mixing said materials to form a homogeneous mixture, said mixture comprising between 30 weight percent and 70 weight percent of said first ceramic material;
(c) forming said mixture into a particle precursor;
(d) heating said precursor to a maximum temperature no less than said first ceramic material's fluid conversion temperature and no greater than said second ceramic material's fluid conversion temperature wherein said first and second ceramic materials cooperate to form an amorphous phase that abuts and embeds an array of predominately crystalline regions; and
(e) cooling said precursor to ambient temperature thereby forming a sintered ceramic particle.

12. The process of claim 11 wherein said amorphous phase forms a continuous matrix through said particle and said crystalline regions collectively form a discontinuous phase.

13. The process of claim 12 wherein said amorphous phase abuts at least one of said predominately crystalline regions at an interface and said interface exhibits stress.

14. The process of claim 13 wherein said stress comprises compressive stress.

15. The process of claim 11 wherein in step (a) i) at least 10 weight percent of said first ceramic material is crystalline, said 10 weight percent based on the total weight of said first ceramic material.

16. The process of claim 15 wherein in step (a) i) at least 20 weight percent of said first ceramic material is crystalline.

17. The process of claim 11 wherein at least 10 weight percent of said second ceramic material is amorphous, said 10 weight percent based on the total weight of said second ceramic material.

18. The process of claim 17 wherein at least 20 weight percent of said second ceramic material is amorphous.

19. The process of claim 11 wherein said first material's fluid conversion temperature is at least 50° C. less than said second material's fluid conversion temperature.

20. The process of claim 11 wherein said second ceramic material comprises alumina.

21. The process of claim 11 wherein said first ceramic material is selected from the group consisting of feldspar and nepheline syenite.

22. The process of claim 11 wherein said particle precursor in step (c) comprises at least 40 weight percent of said first ceramic material.

23. The process of claim 11 wherein said particle precursor in step (c) comprises at least 50 weight percent of said first ceramic material.

24. The process of claim 11 wherein said particle precursor in step (c) comprises less than 60 weight percent of said first ceramic material.

25. The process of claim 11 wherein said particle precursor in step (c) comprises less than 55 weight percent of said second ceramic material.
